(19) United States
(12) Patent Application Publication
(10) Pub. No.: US 2007/0246606 A1
(43) Pub. Date: Oct. 25, 2007

(54) Imperative chute

(76) Inventors: Jean Ann Lewis, Patagonia, AZ (US); Ilene Stotts, Las Vegas, NV (US)

Correspondence Address: Jean Lewis, P O Box 34, Patagonia, AZ, 85624, US

(21) Appl. No.: 11/410,077

(22) Filed: Apr. 25, 2006

(51) Int. Cl. B64C 30/00

(52) U.S. Cl. 244/117 R

(57) ABSTRACT

An aircraft emergency landing assist system comprised of a harness to cradle the major stress points of the aircraft. The harness made of lightweight high tension material attached to the aircraft fuselage. The harness works as a sling with straps coming up each side of the aircraft to attach to a parachute system. In an emergency situation when a parachute is deployed said harness will cradle the body of the aircraft and relieve stress from said body. Pedal in cockpit of aircraft within reach of pilots foot. In an emergency situation, the pilot will push said pedal to activate distress signal, lock the fuel gauge in place A safety feature in the event there are intruders in the cockpit Activate dump fuel switch, activate hydraulic doors when doors are opened, they will activate chute deployment rocket. Said rocket will take canopy to it's full extension.

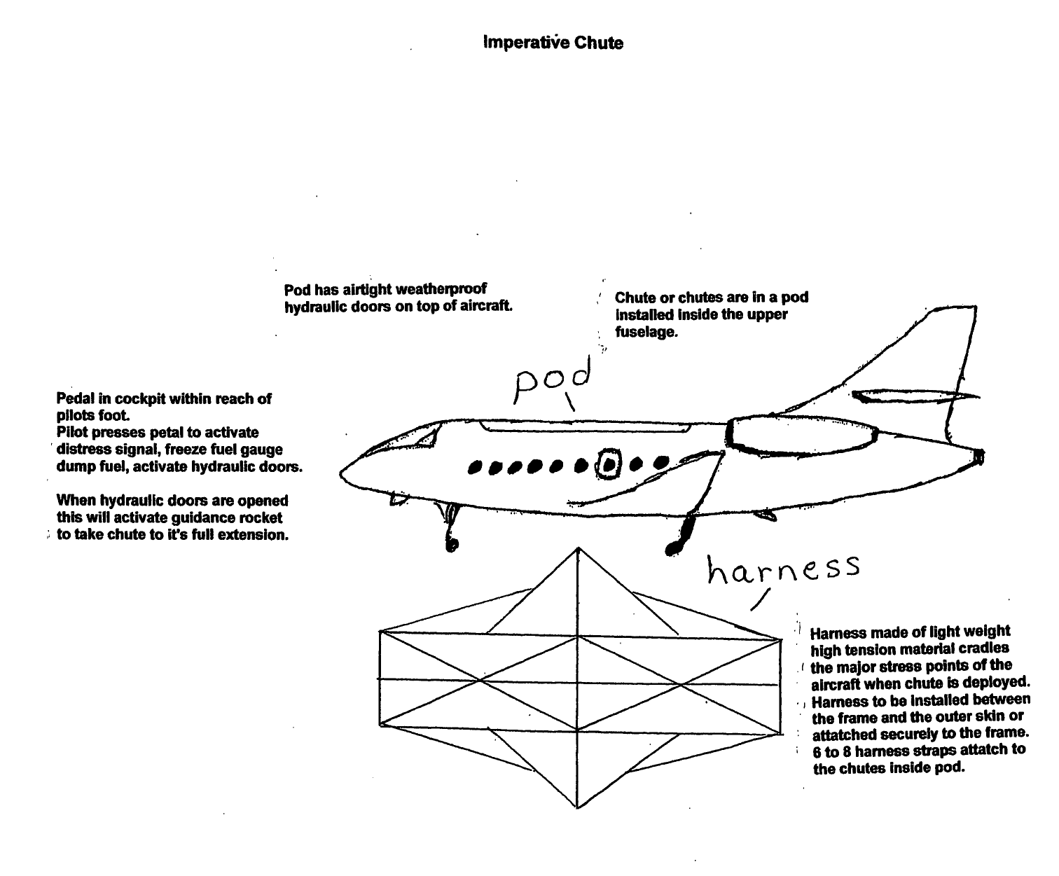

### SUMMARY OF THE INVENTION

We believe Imperative Chute will save lives. We have spent several years investigating and researching this field. In our research, we have discovered that there have been many patents with parachutes for planes. We wish to take it a step further.

The harness cradeling the body of the aircraft will protect the aircraft from undue stress thus prevent it from breaking up. The harness side straps attatch to the parachute inside the pod which is installed inside the upper fuselage. The pod contains the parachute or parachutes and guidance rocket to take the chute to it's full extension.

The size of the aircraft will determine the number of parachutes required. The pod is to be long and as thin as possible to house the parachute. Hydraulic doors to the pod on top of aircraft as small as possible.

A pedal to be installed in the cockpit with in reach of the pilots foot and undetectable by anyone in the cockpit. Preasure on this pedal will be to activate distress signal, dump the fuel while freezing the fuel guage in it's current position and activate hydraulic pod doors. When doors are completely opened, this will activate the guidance rocket to pull the chute from the pod and take it to it's full extention. Freezing the fuel guage is a safety measure in the event of intruders in the cockpit

We believe this is a new and improved invention.

References cited

| | | | |
|---|---|---|---|
| 5409187 | April 1995 | Dunham | 244/149, 139, 102/340 |
| 6042051 | March 2000 | Hagerty | 244/49, 100A; 107, 139 |
| 5826827 | October 1998 | Coyaso | 244/139, 107. 147 |
| 5810293 | September 1998 | Leeky-Woo | 244/139, 147 |
| 4480807 | November 1984 | Bowen | 244/139, 147 |
| 4113208 | September 1978 | Manfredi | 244/139, 147 |
| 3129913 | April 1964 | Smith | 244/139 |
| 2665093 | January 1954 | Manfredi | 244/139 |
| 1823799 | September 1931 | Fredrick | |
| 1733030 | October 1929 | Rosenblum | |
| 2324045 | July 1943 | Vallinos | 244/147 |
| 3051420 | August 1962 | Novak | 244/139 |
| 3499623 | March 1970 | Markham | 244/139 |
| 4050657 | September 1977 | Murphy | 244/139, 147 |

What is claimed is:

1. An aircraft emergency landing assist system comprising;
1. A harness made of high tension reinforced material which must be securely attached to the frame of the aircraft
a) 3 or more harness straps on each side of the aircraft attached to parachute system.
b) Harness is designed to cradle said aircraft and to relieve major stress points of said aircraft.
2) A pod housing the parachute is installed in the upper fuselage.
a) Said pod has air tight weather proof hydraulic doors on top of aircraft.
b) Small rocket is in said pod to guide chute to it's full extension.
3. Pedal in cockpit of said aircraft within reach of pilots foot.
a) In an emergency situation, the pilot will push said pedal.
b) Distress signal is activated.
c) Lock fuel gauge in place. A safety feature if there are intruders in the cockpit.
d) activate dump fuel switch.
e) activate hydraulic doors.
f) When hydraulic doors open, doors will activate said rocket.
g) Canopy made of reinforced light weight material.
